(19) United States
(12) Patent Application Publication
(10) Pub. No.: US 2026/0228321 A1
(43) Pub. Date: Aug. 6, 2026

(54) METHODS, APPARATUSES, DEVICE, AND STORAGE MEDIUM FOR INTERACTION MANAGEMENT

(71) Applicant: Beijing Volcano Engine Technology Co., Ltd., Beijing (CN)

(72) Inventor: Haichao LIU, Beijing (CN)

(21) Appl. No.: 19/144,952

(22) PCT Filed: May 30, 2024
(86) PCT No.: PCT/CN2024/096509

§ 371 Date: Jun. 30, 2025

(30) Foreign Application Priority Data
May 31, 2023 (CN) 202310640144.2

(51) Int. Cl. G06F 21/44; G06F 21/33; G06F 21/64

(52) U.S. Cl. CPC G06F 21/44; G06F 21/33; G06F 21/64

(57) ABSTRACT

Methods, apparatuses, a device, and a storage medium for interaction management are provided. The method of interaction management includes: receiving, by a first device, target information associated with security of software distribution of a second device, the target information including at least one of: a private key issued for the second device; or a software distribution certificate related to the software distribution for the second device; signing at least one software to be distributed at the second device based on the target information; and sending, to the second device, the signed at least one software to be distributed, to enable the second device to perform the software distribution.

This application claims priority to Chinese Patent Application No. 2023106401442, filed on May 31, 2023 and entitled “METHODS, APPARATUSES, DEVICE, AND STORAGE MEDIUM FOR INTERACTION MANAGEMENT”, the entirety of which is incorporated herein by reference.

### FIELD

Example embodiments of the present disclosure generally relate to the field of computers, and in particular, to methods, apparatuses, a device and a computer-readable storage medium for interaction management.

### BACKGROUND

Terminal management systems all have functions such as pushing software to managed terminal devices and executing commands and/or the like. Once management credentials are stolen or the management system is invaded, these management capabilities may be used to push malicious software to the managed terminal devices and execute commands to achieve an aim about controlling more devices. Some software distribution platforms have the ability to push software to all terminal devices, so there is a risk of such attacks.

### SUMMARY

In the first aspect of the present disclosure, a method of interaction management is provided. The method includes receiving, by a first device, target information associated with security of software distribution of a second device, the target information including at least one of: a private key issued for the second device; or a software distribution certificate related to the software distribution for the second device; signing at least one software to be distributed at the second device based on the target information; and sending, to the second device, the signed at least one software to be distributed, to enable the second device to complete the software distribution.

In the second aspect of the present disclosure, a method of interaction management is provided. The method includes receiving, by a second device, from a first device, at least one signed software to be distributed, the at least one software to be distributed being signed by target information associated with security of software distribution of the second device, the target information including at least one of: a private key issued for the second device; or a software distribution certificate related to the software distribution for the second device; performing a security verification on the at least one software to be distributed; and in response to the verification being successful, completing the software distribution.

In the third aspect of the present disclosure, a device for interaction management is provided. The device includes a receiving module configured to receive target information associated with security of software distribution of the second device, the target information including at least one of: a private key issued for the second device; or a software distribution certificate related to the software distribution for the second device; a signature module configured to sign at least one software to be distributed at the second device based on the target information; and a sending module configured to send, to the second device, the signed at least one software to be distributed, to enable the second device to complete the software distribution.

In the fourth aspect of the present disclosure, a device for interaction management is provided. The device includes a receiving module configured to receive, from a first device, at least one signed software to be distributed, the at least one software to be distributed being signed via target information associated with security of software distribution of the device, the target information including at least one of: a private key issued for the device; or a software distribution certificate related to the software distribution for the device; a verification module configured to perform security verification on the at least one software to be distributed; and an execution module configured to in response to the verification being successful, complete the software distribution.

In the fifth aspect of the present disclosure, an electronic device is provided. The device includes at least one processing unit; and at least one memory, the at least one memory coupled to the at least one processing unit and storing commands for execution by the at least one processing unit, the commands, when executed by the at least one processing unit, causing the device to perform the method of the first or the second aspect.

In the sixth aspect of the present disclosure, a computer-readable storage medium is provided. The computer-readable storage medium storing a computer program thereon, the computer program, when executed by a processor, implementing the method of the first or second aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages, and aspects of the various embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure can be implemented;

FIG. 2 illustrates a schematic diagram of an interaction process of interaction management according to some embodiments of the present disclosure;

FIG. 3 illustrates a schematic diagram of the interaction process of interaction management according to some embodiments of the present disclosure;

FIG. 4 illustrates a schematic diagram of the interaction process of interaction management according to some embodiments of the present disclosure;

FIG. 5 illustrates a schematic diagram of the interaction process of interaction management according to some embodiments of the present disclosure;

FIG. 6 illustrates a flowchart of a process of interaction management according to some embodiments of the present disclosure;

FIG. 7 illustrates a flowchart of the process of interaction management according to some embodiments of the present disclosure;

FIG. 8 illustrates a block diagram of an apparatus for interaction management according to some embodiments of the present disclosure;

FIG. 9 illustrates a block diagram of an apparatus for interaction management according to some embodiments of the present disclosure; and

FIG. 10 illustrates a block diagram of an electronic device capable of implementing various embodiments of the present disclosure.

### DETAILED DESCRIPTION

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

In the description of the embodiments of the present disclosure, the term “comprising”, and similar terms would be appreciated as open inclusion, that is, “comprising but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

As mentioned above, in a case that management credentials are stolen and/or management systems are invaded, there is a potential risk of malicious software attacks in the process of software distribution platforms pushing software to terminal devices. Once this malicious software is installed and executed by a terminal device, the terminal device may be controlled.

Various embodiments described herein propose a solution for interaction management. A software distribution device may receive target information associated with security of software distribution of a terminal device. The target information may include a private key issued for the terminal device or a software distribution certificate related to the software distribution of the terminal device. The software distribution device signs at least one software to be distributed, based on the target information. The software distribution device sends the signed at least one software to be distributed to the terminal device, to complete the distribution of the software, for example installing software or executing related commands.

According to embodiments of the present disclosure, by using a public key or a certificate signature verification technique to perform security verification on the software distribution, in a case that there is a security vulnerability in a management background or a server is invaded, a potential risk for software distribution may be avoided.

### Example Environment

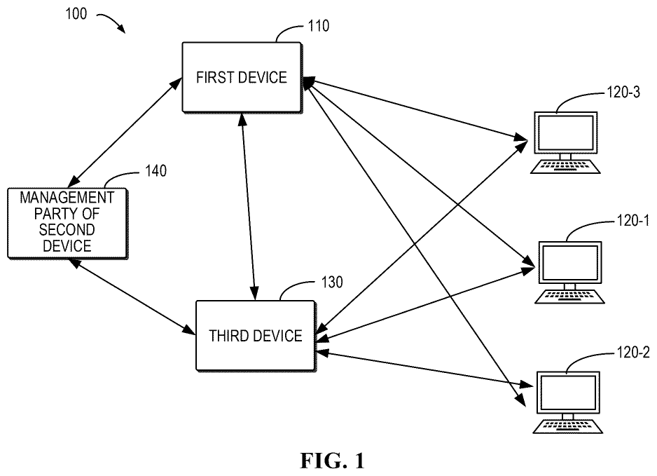

Reference is first made to FIG. 1 which schematically illustrates a schematic diagram of an example environment 100 in which example implementations can be implemented according to the present disclosure.

As shown in FIG. 1, the environment 100 may include a first device 110 and a plurality of second devices 120-1, 120-2 and 120-3 connected with the first device 110.

The first device 110 is a device capable of implementing software distribution operations. For example, the first device 110 may be a device capable of carrying a digital office platform, capable of implementing functions including, but not limited to integrate identity and permission management, remote access connection, office network access, terminal asset management and office security capabilities.

The plurality of second devices 120-1, 120-2 and 120-3 may be deployed at the terminal side and may use the functions provided by the first device 110. In the embodiments of the present application, the plurality of second devices 120-1, 120-2 and 120-3 may also be collectively referred to as the second devices 120. The example environment 100 also includes a management party 140 of the second device. The plurality of second devices 120-1, 120-2 and 120-3 may be managed by the management party 140 of the second device.

The second device 120 may be any type of mobile terminals, fixed terminals, or portable terminals, including a mobile phone, a desktop computer, a laptop, a netbook, a tablet, a media computer, a multimedia tablet, a personal communication system (PCS) device, a personal navigation device, a personal digital assistant (PDA), an audio/video player, a digital camera/camera, a positioning device, a television receiver, a radio broadcast receiver, an e-book device, a gaming device, or any combination of the aforementioned, and including accessories and peripherals of these devices or any combination thereof. In some embodiments, the second device 120 may also support any type of user specific interfaces (such as a “wearable” circuit, etc.).

In some embodiments, the first device 110 may push software to the plurality of second devices 120-1, 120-2 and 120-3 to enable software installation or execution of corresponding commands on the plurality of second devices 120-1, 120-2 and 120-3.

In some embodiments, the management party 140 of the second device may be connected with the first device 110 to grant, to the first device 110, permission and/or related security verification information to distribute or push software to the plurality of second devices 120-1, 120-2 and 120-3 managed by the management party 140 of the second device. In addition, in some embodiments, the management party 130 of the second device 120 may also provide, to the first device 110, indications for software to be pushed to the plurality of second devices 120-1, 120-2 and 120-3.

In some embodiments, the example environment 100 also includes a third device 130. The third device 130 may be, for example, various types of computing systems/servers capable of providing computing power, including, but not limited to a mainframe, an edge computing node, a computing device in cloud environment, and/or the like. For example, the third device 130 may be connected to the first device 110, the second device 120, and the management party 140 of the second device, respectively, to provide support for security verification during software distribution.

It would be appreciated that the structure and function of the environment 100 is described only for illustrative purposes and does not imply any limitations on the scope of the present disclosure.

### Example Processes of Interaction Management

FIGS. 2 to 5 illustrate schematic diagrams of processes 200 to 500 for interaction management according to some embodiments of the present disclosure. The processes 200 to 500 may involve the first device 110, the second device 120, the third device 130, and the management party 140 of the second device. For the purpose of discussions, the process 200 will be described with reference to the environment 100 in FIG. 1.

As shown in FIGS. 2 to 5, the first device 110 may include a front-end client platform 110-1 and a back-end server 110-2. As an example, the front-end client platform 110-1 may be connected with the management party 140 of the second device to receive commands from the management party 140 of the second device. The back-end servers 110-2 may be connected to the second device 120 to achieve the software distribution. These components/modules may be integrated into the first device 110 or implemented independently of each other. It would be appreciated that the first device 110 may also include other suitable units/modules, the scope of the present disclosure is not limited in this regard.

FIG. 2 illustrates a schematic diagram of a process 200 for interaction management according to some embodiments of the present disclosure.

As shown in FIG. 2, the third device 130 may generate a public-private key pair issued for the second device 120, and provide (202) the private key to the management party 140 of the second device. For example, the issued public-private key pair may be used for security verification of software distribution for the second device 120. In some other embodiments, the public-private key pair may also be generated by the management party 140 of the second device. The management party 140 of the second device saves the private key and provides the corresponding public key to the third device 130.

During the software distribution process, the management party 140 of the second device provides (204) a software to be distributed and a private key issued for the second device 120 to the first device 110. For example, the management party 140 of the second device provides a private key to the front-end client platform 110-1. At the front-end client platform 110-1, the private key is used to sign (206) the software to be distributed to generate a software signature string, and provide (208) the software to be distributed and the software signature string to the back-end server 110-2.

Alternatively, or in addition, the action of signing the software to be distributed to generate the software signature string may also be executed by the back-end server 110-2. For example, the front-end client platform 110-1 provides the private key to the back-end server 110-2. After receiving the corresponding software package to be distributed, the back-end server 110-2 may use the private key to sign the software to be distributed, to generate the software signature string.

The second device 120 may obtain (210) a public key corresponding to the private key from the third device 130, which is issued for the second device 120. After receiving (212), from the first device 110 (for example the back-end server 110-2), the software package to be distributed and the software signature string, the second device 120 uses the public key to perform security verification (214) on the software signature string. If it is determined that the verification is successful, the software distribution is completed, for example, executing the installation of the software or corresponding instructions, and/or the like.

In some embodiments, the second device 120 may also obtain, from the third device 130, information on whether its management party 140 has enabled the software distribution public key signature verification. In some embodiments, the obtaining and verification of the security information may be performed at each startup of the second device 120.

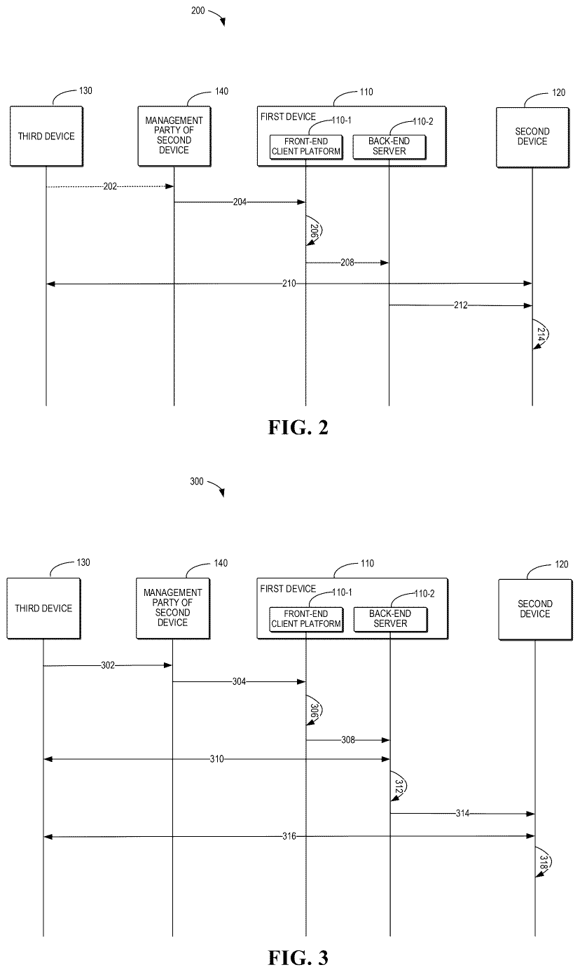

In some embodiments, the management party 140 of the second device may disable the security verification process for the software distribution mentioned above. FIG. 3 illustrates a schematic diagram of a process 300 for interaction management according to some embodiments of the present disclosure.

As shown in FIG. 3, the third device 130 may generate a public-private key pair issued for the second device 120, and provide (302) the private key to the management party 140 of the second device. For example, the issued public-private key pair may be used to shutdown the security verification of the software distribution of the second device 120.

The management party 140 of the second device provides (304) a shutdown command for the private key issued for the second device 120 and the security verification for the software distribution to the first device 110. For example, the management party 140 of the second device provides a private key to the front-end client platform 110-1, and this private key is used to sign (306) the shutdown command at the front-end client platform 110-1 to generate a command signature string. The front-end client platform 110-1 provides (308) the shutdown command and the command signature string to the back-end server 110-2.

The back-end server 110-2 may obtain, from the third device 130, the public key corresponding to the private key, issued for the second device 120. After receiving, from the front-end client platform 110-1, the shutdown command and the command signature string, the back-end server 110-2 uses this public key to perform (312) the security verification on the command signature string. If it is determined that the verification is successful, the back-end server 110-2 determines that the shutdown command is trust-worthy, and then the first device 110 provides (314), by the back-end server 110-2, the shutdown command and the command signature string to the second device 120.

The second device 120 may obtain (316), from the third device 130, a public key corresponding to the private key, issued for the second device 120. The second device 120 verifies the command signature string again using the public key. If it is determined that the verification is successful, the second device 120 executes (318) the shutdown command for the security verification of the software distribution.

Through the above approaches, the terminal device cannot complete the software distribution or shutdown the security verification until the verification is successful. By using the public key for verification, even in a case that there is a security vulnerability in the management party of the terminal device, malicious tampering and attack risks in software distribution may be avoided.

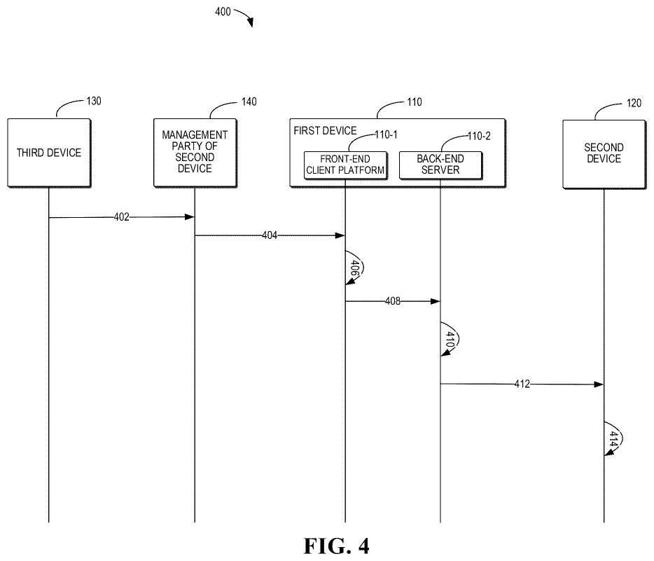

In some other embodiments, the security verification for the software distribution may also be implemented by the security certificate. FIG. 4 illustrates a schematic diagram of a process 400 for interaction management according to some embodiments of the present disclosure.

As shown in FIG. 4, the third device 130 may serve as a certificate issuing authority. For example, the third device 130 may issue, for the management party 140 of the second device, a software distribution certificate related to the software distribution of the second device 120. It would be appreciated that the software distribution certificate issued by the third device 130 to the management party 140 of the second device may include identification information for the second device 120, so that the software distribution certificate is dedicated to the second device 120. The second device 120 may be pre-configured with a root certificate of the software distribution certificate.

The third device 130 provides (402) the software distribution certificate to the management party 140 of the second device. During the software distribution process, the management party 140 of the second device provides (404) the software to be distributed and a certificate chain and the private key to the first device 110. For example, the management party 140 of the second device provides the software to be distributed and the certificate chain and the private key to the front-end client platform 110-1, so that the certificate chain and the private key are used to sign (406) the software to be distributed at the front-end client platform 110-1 to generate a software signature certificate chain and provide (408) the software to be distributed and the software signature certificate chain to the back-end server 110-2.

Alternatively, or in addition, the action of signing the software to be distributed to generate the software signature certificate chain may also be performed by the back-end server 110-2. For example, the front-end client platform 110-1 provides the private key and the certificate chain to the back-end server 110-2. After receiving the corresponding software package to be distributed, the back-end server 110-2 may use the private key and the certificate chain to sign the software to be distributed, to generate (410) the software signature certificate chain.

After receiving (412), from the first device 110 (for example the back-end server 110-2), the software package to be distributed and the software signature certificate chain, the second device 120 uses the public key in the pre-configured root certificate to perform security verification (414) for the software signature certificate chain. If it is determined that the verification is successful, the software distribution is completed, for example, executing the installation of the software or corresponding instructions, and/or the like.

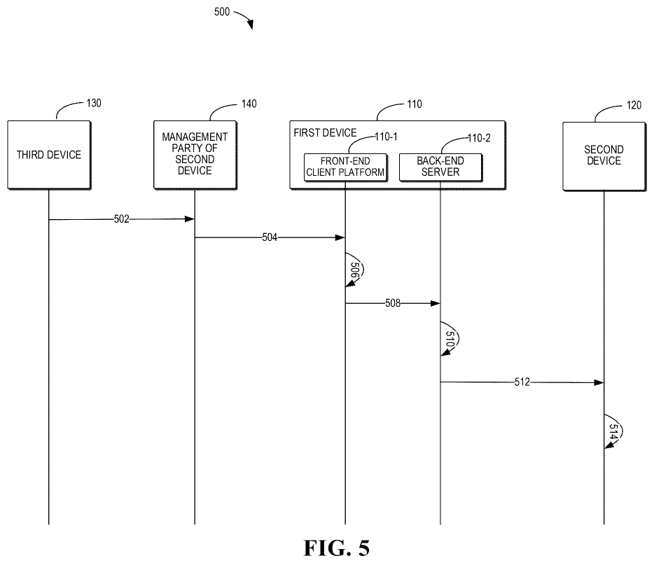

In some embodiments, the management party 140 of the second device may disable the security verification process for software distribution operations mentioned above. FIG. 5 illustrates a schematic diagram of a process 500 for interaction management according to some embodiments of the present disclosure.

As shown in FIG. 5, the third device 130 provides (502) a software distribution certificate to the management party 140 of the second device.

The management party 140 of the second device provides (504) a certificate chain for the software distribution certificate and a shutdown command for the security verification of the software distribution to the first device 110. For example, the management party 140 of the second device provides the certificate chain to the front-end client platform 110-1, and this certificate chain is used at the front-end client platform 110-1 to sign (506) the shutdown command to generate a command signature certificate chain. The front-end client platform 110-1 provides (508) the shutdown command and the command signature certificate chain to the back-end server 110-2.

The back-end server 110-2 may be pre-configured with the root certificate of the software distribution certificate. The back-end server 110-2 may use the public key of the root certificate to perform (510) the security verification on the command signature certificate chain. If it is determined that the verification is successful, the back-end server 110-2 determines that the shutdown command is trust-worthy, and then the first device 110 provides (512), by the back-end server 110-2, the shutdown command and the command signature certificate chain to the second device 120.

Similarly, the second device 120 uses the public key in the pre-configured root certificate to verify the command signature certificate chain. If it is determined that the verification is successful, the second device 120 executes (514) the shutdown command of the security verification of the software distribution.

Through the above approaches, using the public-private key pair and/or the security certificate to perform security verification for software distribution, the security of the system may be ensured in the maximized extent. Even in a case that there is a security vulnerability in the management back-end or server intrusions are invaded, as long as the private key is not leaked, the software distribution may not be affected.

### Example Processes

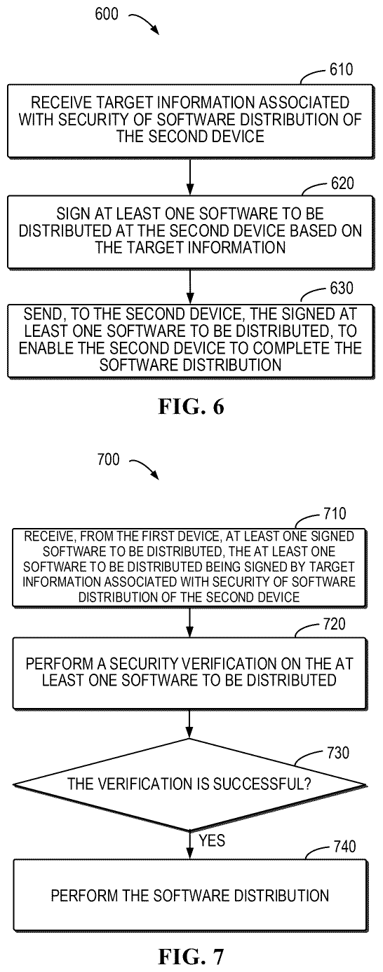

FIG. 6 shows a flowchart of a process 600 of interaction management according to some embodiments of the present disclosure. In some embodiments, for example, the process 600 may be implemented by the first device 110.

At block 610, the first device 110 receives target information associated with security of software distribution of the second device. The target information includes at least one of: a private key issued for the second device; or a software distribution certificate related to the software distribution for the second device.

At block 620, the first device 110 signs at least one software to be distributed at the second device based on the target information.

At block 630, the first device 110 sends, to the second device, the signed at least one software to be distributed, to enable the second device to complete the software distribution.

In some embodiments, the first device may obtain the at least one software to be distributed and the private key; generate a software signature string by signing the at least one software to be distributed using the private key; and send, to the second device, the at least one software to be distributed and the software signature string generated by signing the at least one software to be distributed using the private key.

In some embodiments, the first device may in response to detecting a shutdown command for a security verification of the software distribution, obtain a public key issued for the second device, corresponding to the private key, where the shutdown command for the security verification is signed by the private key; verify the signed close command using the public key; and in response to the verification being successful, send, to the second device, the shutdown command and the command signature string generated by signing the secure command using the private key.

In some embodiments, the private key issued for the second device is obtained from an administrator of the second device or obtained from a third device.

In some embodiments, the first device may obtain the at least one software to be distributed and the software distribution certificate; generate a software signature certificate chain by signing the at least one software to be distributed using a private key of the software distribution certificate; and send, to the second device, the software signature certificate chain and the at least one signed software to be distributed.

In some embodiments, the first device may in response to detecting a shutdown command for a security verification of the software distribution, obtain a public kay of the software distribution certificate corresponding to the private key, where the shutdown command for the verification is signed by a private key of the software distribution certificate; verify, using the public key of the software distribution certificate, a command signature certificate chain generated by signing the shutdown command with the private key of the software distribution certificate; and in response to the verification being successful, send the shutdown command and the command signature certificate chain to the second device.

FIG. 7 shows a flowchart of process 700 for interaction management according to some embodiments of the present disclosure. In some embodiments, for example, the process 700 may be implemented by the second device 120.

At block 710, the second device 120 receives, from a first device, at least one signed software to be distributed, the at least one software to be distributed is signed by target information associated with security of software distribution of the second device, the target information including at least one of: a private key issued for the second device; or a software distribution certificate related to the software distribution for the second device.

At block 720, the second device 120 performs a security verification on the at least one software to be distributed.

At block 730, verification at the second device 120 is successful, and then at block 740, the second device 120 completes the software distribution.

In some embodiments, the second device may obtain a public key issued for the second device, corresponding to the private key; and verify a software signature string using the public key, the software signature string is generated by signing the at least one software to be distributed using the private key.

In some embodiments, the second device may in response to receiving a shutdown command to shutdown a security verification for the software distribution, obtain a public key issued for the second device, corresponding to the private key ; verify a command signature certificate chain using the public key, the command signature certificate chain is generated by signing the shutdown command using the private key; and in response to the verification being successful, execute the shutdown command.

In some embodiments, the second device may obtain a public key of the software distribution certificate; and verify a software signature string using the public key, the software signature string is generated by signing the at least one software to be distributed using a private key of the software distribution certificate.

In some embodiments, the second device may in response to receiving a shutdown command to shutdown a security verification for the software distribution, obtain a public key of the software distribution certificate; verify a command signature certificate chain using the public key, the command signature certificate chain is generated by signing the shutdown command using a private key of the software distribution certificate; and in response to the verification being successful, execute the shutdown command.

Through the solution of the present disclosure, the system security during the software distribution may be significantly improved.

### Example Apparatuses and Device

The embodiments of the present disclosure also provide corresponding devices for implementing the above methods or processes. FIG. 8 shows a schematic structural diagram of a device 800 for interaction management according to some embodiments of the present disclosure.

As shown in FIG. 8, the device 800 may include a receiving module 810 configured to receive target information associated with security of software distribution of the second device, the target information including at least one of: a private key issued for the second device; or a software distribution certificate related to the software distribution for the second device. The device 800 may include a signature module 820 configured to sign at least one software to be distributed at the second device based on the target information. The device 800 may further include a sending module 830 configured to send, to the second device, the signed at least one software to be distributed, to enable the second device to complete the software distribution.

In some embodiments, the sending module 830 is further configured to obtain the at least one software to be distributed and the private key; generate a software signature string by signing the at least one software to be distributed using the private key; and send, to the second device, the at least one software to be distributed and the software signature string generated by signing the at least one software to be distributed using the private key.

In some embodiments, the device 800 is further configured to in response to detecting a shutdown command for a security verification of the software distribution, obtain a public key issued for the second device, corresponding to the private key, where the shutdown command for the security verification is signed by the private key; verify the signed shutdown command using the public key; and in response to the verification being successful, send, to the second device, the shutdown command and the command signature string generated by signing the security command using the private key.

In some embodiments, the private key issued for the second device is obtained from an administrator of the second device or obtained from a third device.

In some embodiments, the device 800 is further configured to obtain the at least one software to be distributed and the software distribution certificate; generate a software signature certificate chain by signing the at least one software to be distributed using a private key of the software distribution certificate; and send, to the second device, the software signature certificate chain and the at least one signed software to be distributed.

In some embodiments, the device 800 is further configured to in response to detecting a shutdown command for a security verification of the software distribution, obtain a public key of the software distribution certificate corresponding to the private key, where the shutdown command for the security verification is signed by a private key of the software distribution certificate; verify, using the public key of the software distribution certificate, a command signature certificate chain generated by signing the shutdown command with the private key of the software distribution certificate; and in response to the verification being successful, send the shutdown command and the command signature certificate chain to the second device.

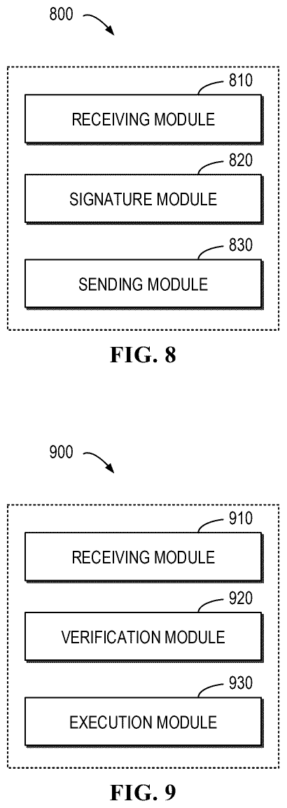

FIG. 9 illustrates a schematic structural diagram of an apparatus 900 for interaction management according to some embodiments of the present disclosure.

As shown in FIG. 9, device 900 may include a receiving module 910 configured to receive, from the first device, at least one signed software to be distributed, the at least one software to be distributed is signed via target information associated with security of software distribution of the device, the target information including at least one of: a private key issued for the device; or a software distribution certificate related to the software distribution for the device. The device 900 may include a verification module 920 configured to perform security verification on the at least one software to be distributed. The device 900 may further include an execution module 930 configured to in response to the verification being successful, complete the software distribution.

In some embodiments, the device 900 is further configured to obtain a public key issued for the second device, corresponding to the private key; and verify a software signature string using the public key, the software signature string is generated by signing the at least one software to be distributed using the private key.

In some embodiments, the device 900 is further configured to in response to receiving a shutdown command to shutdown a security verification for the software distribution, obtain a public key issued for the second device, corresponding to the private key; verify a command signature certificate chain using the public key, the command signature certificate chain is generated by signing the shutdown command using the private key; and in response to the verification being successful, execute the shutdown command.

In some embodiments, the device 900 is further configured to obtain a public key of the software distribution certificate; and verify a software signature string using the public key, the software signature string is generated by signing the at least one software to be distributed using a private key of the software distribution certificate.

In some embodiments, the device 900 is further configured to in response to receiving a shutdown command to shutdown a security verification for the software distribution, obtain a public key of the software distribution certificate; verify a command signature certificate chain using the public key, the command signature certificate chain is generated by signing the shutdown command using a private key of the software distribution certificate; and in response to the verification being successful, execute the shutdown command.

The units included in the device 800 and/or the device 900 may be implemented in various ways, including a software, a hardware, a firmware, or any combination thereof. In some embodiments, one or more units may be implemented using a software and/or a firmware, for example machine executable commands stored on a storage medium. In addition to the machine executable commands or as an alternative, part or all of the units in the device 800 and/or the device 900 may be implemented, at least partially, by one or more hardware logic components. As an example rather than a limitation, demonstration types of the hardware logic components that may be used include Field Programmable Gate Arrays (FPGAs), Application Specific Integrated Circuits (ASICs), Application Specific Standards (ASSPs), System on Chip (SOC), Complex Programmable Logic Devices (CPLDs), and so on.

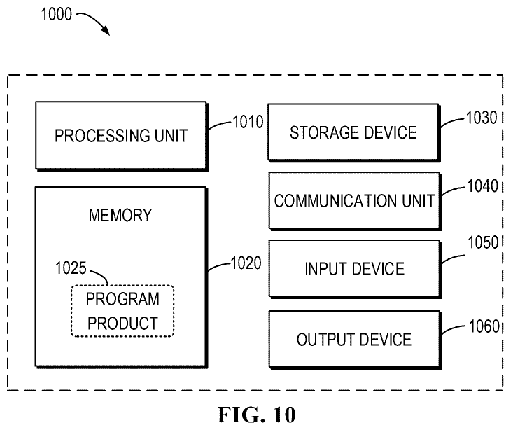

FIG. 10 illustrates a block diagram of an electronic device/server 1000 in which one or more embodiments of the present disclosure may be implemented. It should be understood that the electronic device/server 1000 shown in FIG. 10 is only exemplary and should not constitute any limitation on the functionality and scope of the embodiments described herein.

As shown in FIG. 10, the electronic device/server 1000 is in the form of a general-purpose electronic device. Components of electronic device/server 1000 may include, but are not limited to, one or more processors or processing units 1010, a memory 1020, a storage device 1030, one or more communication units 1040, one or more input devices 1050, and one or more output devices 1060. The processing unit 1010 may be an actual or virtual processor and may perform various processes according to programs stored in the memory 1020. In a multiprocessor system, a plurality of processing units execute electronic executable commands in parallel to improve the parallel processing capability of electronic device/server 1000.

The electronic device/server 1000 typically includes a number of computer storage media. Such media may be any accessible media that are accessible by electronic device/server 1000, including, but not limited to, volatile and non-volatile media, removable and non-removable media. The memory 1020 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 1030 may be a removable or non-removable medium and may include machine readable media such as a flash drive, a magnetic disk, or any other medium that may be used to store information and/or data (e.g., training data for training) and that may be accessed within the electronic device/server 1000.

The electronic device/server 1000 may further include additional removable/non-removable, volatile/non-volatile storage media. Although not shown in FIG. 10, a magnetic disk drive for reading from or writing to a removable, non-volatile disk such as a “floppy disk” and an optical disk drive for reading from or writing to a removable, non-volatile optical disk may be provided. In these cases, each drive may be connected to a bus (not shown) by one or more data media interfaces. The memory 1020 may include a computer program product 1025 having one or more program modules configured to perform various methods or actions of various embodiments of the present disclosure.

The communication unit 1040 implements communication with other electronic devices through a communication medium. Additionally, functions of components of the electronic device/server 1000 may be implemented by a single computing cluster or a plurality of computing machines, and these computing machines may communicate through a communication connection. Thus, the electronic device/server 1000 may operate in a networked environment using logical connections to one or more other servers, network personal computers (PCs), or another network node.

The input device 1050 may be one or more input devices, such as a mouse, a keyboard, a trackball, etc. The output device 1060 may be one or more output devices, such as a display, a speaker, a printer, etc. The electronic device/server 1000 may also communicate with one or more external devices (not shown) through the communication unit 1040 as required. The external device, such as a storage device, a display device, etc., communicate with one or more devices that enable users to interact with the electronic device/server 1000, or communicate with any device (for example, a network card, a modem, etc.) that makes the electronic device/server 1000 to communicate with one or more other electronic devices. Such communication may be executed via an input/output (I/O) interfaces (not shown).

According to example implementation of the present disclosure, there is provided a computer-readable storage medium on which a computer-executable command is stored, where one or more computer commands are executed by a processor to implement the methods described above.

Various aspects of the present disclosure are described herein with reference to the flowchart and/or the block diagram of the method, the device (system), and the computer program product implemented in accordance with the present disclosure. It would be appreciated that each block of the flowchart and/or the block diagram, and the combination of each block in the flowchart and/or the block diagram may be implemented by computer-readable program commands.

These computer-readable program commands may be provided to the processing units of general-purpose computers, special computers, or other programmable data processing devices to produce a machine that generates a device to implement the functions/actions specified in one or more blocks in the flowchart and/or block diagram when these commands are executed through the processing units of the computer or other programmable data processing devices. These computer-readable program commands may also be stored in a computer-readable storage medium. These commands enable a computer, a programmable data processing device and/or other devices to work in a specific way. Therefore, the computer-readable medium containing the commands includes a manufacturing product, which includes commands operable to implement various aspects of the functions/actions specified in one or more blocks in the flowchart and/or the block diagrams.

The computer-readable program commands may also be loaded onto a computer, other programmable interaction management devices, or other devices, so that a series of operational steps can be performed on a computer, other programmable interaction management devices, or other devices, to generate a computer-implemented process, such that the commands executed on the computer, other programmable interaction management apparatus, or other devices are operable to implement the functions/actions specified in one or more blocks in the flowchart and/or the block diagrams.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment, or commands, which includes one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer commands.

Each implementation of the present disclosure has been described above. The above description provides a number of examples, not exhaustive, and is not limited to the disclosed implementations. Without departing from the scope and spirit of the described implementations, many modifications and changes are obvious to ordinary skill in the art. The selection of terms used in this article aims to best explain the principles, practical application, or improvement of technology in the market of each implementation, or to enable others of ordinary skill in the art to understand the various embodiments disclosed herein.

1-15. (canceled)

16. A method of interaction management, comprising:
receiving, by a first device, target information associated with security of software distribution of a second device, the target information including at least one of: a private key issued for the second device; or a software distribution certificate related to the software distribution for the second device;
signing at least one software to be distributed at the second device based on the target information; and
sending, to the second device, the signed at least one software to be distributed, to enable the second device to complete the software distribution.

17. The method of claim 16, wherein sending the signed at least one software to be distributed comprises:
obtaining the at least one software to be distributed and the private key;
generating a software signature string by signing the at least one software to be distributed using the private key; and
sending, to the second device, the at least one software to be distributed and the software signature string generated by signing the at least one software to be distributed using the private key.

18. The method of claim 16, further comprising:
in response to detecting a shutdown command for a security verification of the software distribution, obtaining a public key issued for the second device, corresponding to the private key, wherein the shutdown command for the security verification is signed by the private key;
verifying the signed shutdown command using the public key; and
in response to the verification being successful, sending, to the second device, the shutdown command and a command signature string generated by signing the security command using the private key.

19. The method of claim 16, wherein the private key issued for the second device is obtained from an administrator of the second device or obtained from a third device.

20. The method of claim 16, further comprising:
obtaining the at least one software to be distributed and the software distribution certificate;
generating a software signature certificate chain by signing the at least one software to be distributed using a private key of the software distribution certificate; and
sending, to the second device, the software signature certificate chain and the at least one signed software to be distributed.

21. The method of claim 16, further comprising:
in response to detecting a shutdown command for a security verification of the software distribution obtaining a public key of the software distribution certificate corresponding to the private key, wherein the shutdown command for the security verification is signed by a private key of the software distribution certificate;
verifying, using the public key of the software distribution certificate, a command signature certificate chain generated by signing the shutdown command with the private key of the software distribution certificate; and
in response to the verification being successful, sending the shutdown command and the command signature certificate chain to the second device.

22. A method of interaction management, comprising:
receiving, by a second device, from a first device, at least one signed software to be distributed, the at least one software to be distributed being signed by target information associated with security of software distribution of the second device, the target information including at least one of: a private key issued for the second device; or a software distribution certificate related to the software distribution for the second device;
performing a security verification on the at least one software to be distributed; and
in response to the verification being successful, completing the software distribution.

23. The method of claim 22, further comprising:
obtaining a public key issued for the second device, corresponding to the private key; and
verifying a software signature string using the public key, the software signature string being generated by signing the at least one software to be distributed using the private key.

24. The method of claim 22, further comprising:
in response to receiving a shutdown command to shutdown a security verification for the software distribution, obtaining a public key issued for the second device, corresponding to the private key;
verifying a command signature certificate chain using the public key, the command signature certificate chain being generated by signing the shutdown command using the private key; and
in response to the verification being successful, executing the shutdown command.

25. The method of claim 22, further comprising:
obtaining a public key of the software distribution certificate; and
verifying a software signature string using the public key, the software signature string being generated by signing the at least one software to be distributed using a private key of the software distribution certificate.

26. The method of claim 22, further comprising:
in response to receiving a shutdown command to shutdown a security verification for the software distribution, obtaining a public key of the software distribution certificate;
verifying a command signature certificate chain using the public key, the command signature certificate chain being generated by signing the shutdown command using a private key of the software distribution certificate; and
in response to the verification being successful, executing the shutdown command.

27. An electronic device, comprising:
at least one processing unit; and
at least one memory, the at least one memory coupled to the at least one processing unit and storing commands for execution by the at least one processing unit, the commands, when executed by the at least one processing unit, causing the electronic device to perform acts comprising:
receiving, by a first device, target information associated with security of software distribution of a second device, the target information including at least one of: a private key issued for the second device; or a software distribution certificate related to the software distribution for the second device;
signing at least one software to be distributed at the second device based on the target information; and
sending, to the second device, the signed at least one software to be distributed, to enable the second device to complete the software distribution.

28. The electronic device of claim 27, wherein sending the signed at least one software to be distributed comprises:
obtaining the at least one software to be distributed and the private key;
generating a software signature string by signing the at least one software to be distributed using the private key; and
sending, to the second device, the at least one software to be distributed and the software signature string generated by signing the at least one software to be distributed using the private key.

29. The electronic device of claim 28, wherein the acts further comprise:
in response to detecting a shutdown command for a security verification of the software distribution, obtaining a public key issued for the second device, corresponding to the private key, wherein the shutdown command for the security verification is signed by the private key;
verifying the signed shutdown command using the public key; and
in response to the verification being successful, sending, to the second device, the shutdown command and a command signature string generated by signing the security command using the private key.

30. The electronic device of claim 27, wherein the private key issued for the second device is obtained from an administrator of the second device or obtained from a third device.

31. The electronic device of claim 27, wherein the acts further comprise:
obtaining the at least one software to be distributed and the software distribution certificate;
generating a software signature certificate chain by signing the at least one software to be distributed using a private key of the software distribution certificate; and
sending, to the second device, the software signature certificate chain and the at least one signed software to be distributed.

32. The electronic device of claim 27, wherein the acts further comprise:
in response to detecting a shutdown command for a security verification of the software distribution obtaining a public key of the software distribution certificate corresponding to the private key, wherein the shutdown command for the security verification is signed by a private key of the software distribution certificate;
verifying, using the public key of the software distribution certificate, a command signature certificate chain generated by signing the shutdown command with the private key of the software distribution certificate; and
in response to the verification being successful, sending the shutdown command and the command signature certificate chain to the second device.

33. An electronic device, comprising:
at least one processing unit; and
at least one memory, the at least one memory coupled to the at least one processing unit and storing commands for execution by the at least one processing unit, the commands, when executed by the at least one processing unit, causing the electronic device to perform the method of claim 22.

34. A non-transitory computer-readable storage medium storing a computer program thereon, the computer program, when executed by a processor, implementing the method of claim 16.

35. A non-transitory computer-readable storage medium storing a computer program thereon, the computer program, when executed by a processor, implementing the method of claim 22.
